(19) United States
(12) Patent Application Publication
(10) Pub. No.: US 2019/0331988 A1
(43) Pub. Date: Oct. 31, 2019

(54) OPTICAL PROJECTOR MODULE

(71) Applicants: TRIPLE WIN TECHNOLOGY(SHENZHEN) CO.LTD., Shenzhen (TW); HON HAI PRECISION INDUSTRY CO., LTD., New Taipei (TW)

(72) Inventors: SHIN-WEN CHEN, New Taipei (TW); JING-WEI LI, Shenzhen (CN); SHENG-JIE DING, Shenzhen (CN); JIAN-CHAO SONG, Shenzhen (CN)

(21) Appl. No.: 16/022,957

(22) Filed: Jun. 29, 2018

(30) Foreign Application Priority Data
Apr. 25, 2018 (CN) 201810381221.6

(51) Int. Cl. G03B 21/16; G03B 21/14; G02B 27/42

(52) U.S. Cl. CPC G03B 21/16; G02B 27/425; G03B 21/145

(57) ABSTRACT

An optical projector module protected against image distortion caused by heat building up in the light-emitting element includes a printed circuit board, and a light emitting element and an optical member mounted on the printed circuit board. The optical member includes a supporting structure which forms a housing. The housing contains the light emitting element, and a dissipating member made of electrically and thermally conductive metal is embedded on an inner surface of the housing. The housing extends outside of the housing and forms a path to carry away heat generated.

### FIELD

The subject matter herein generally relates to optical projectors.

### BACKGROUND

An optical projector module includes a printed circuit board and a light emitting element mounted on the printed circuit board. The light emitting element can generate a lot of heat and the heat can be difficult to dissipate. The heat can lead to the light beam emitted by the light emitting element being distorted.

Therefore, there is room for improvement in the art.

### BRIEF DESCRIPTION OF THE DRAWINGS

Implementations of the present technology will now be described, by way of example only, with reference to the attached figures.

FIG. 1 is an isometric view of an optical projector module in accordance with one embodiment.

FIG. 2 is an exploded isometric view of the optical projector module in FIG.

FIG. 3 is an isometric view of a supporting structure in the optical projector module in FIG. 1.

FIG. 4 is a cross-sectional view of the optical projector module in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

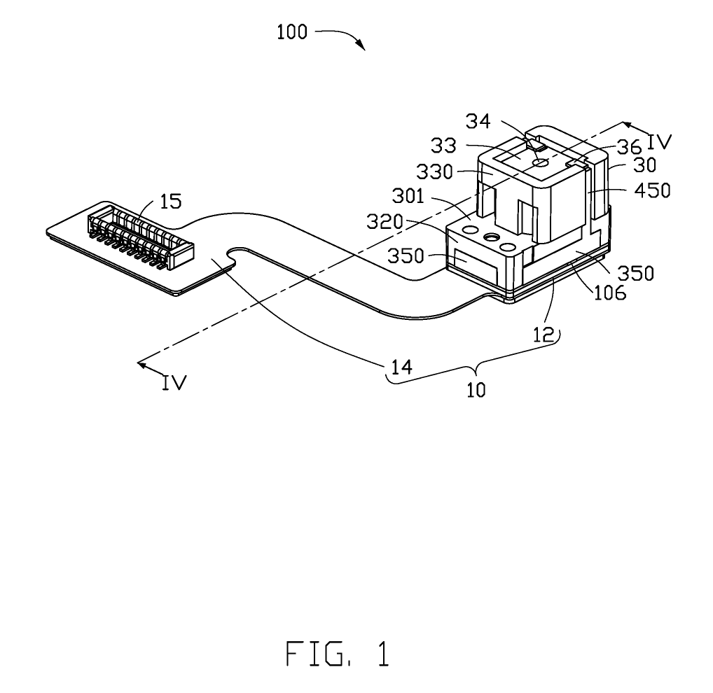

FIG. 1 illustrates an optical projector module 100 according to one embodiment. The optical projector module 100 includes a printed circuit board 10, a light emitting element 20 mounted on the printed circuit board 10, and an optical member 30 mounted on the printed circuit board 10 and shading the light emitting element 20.

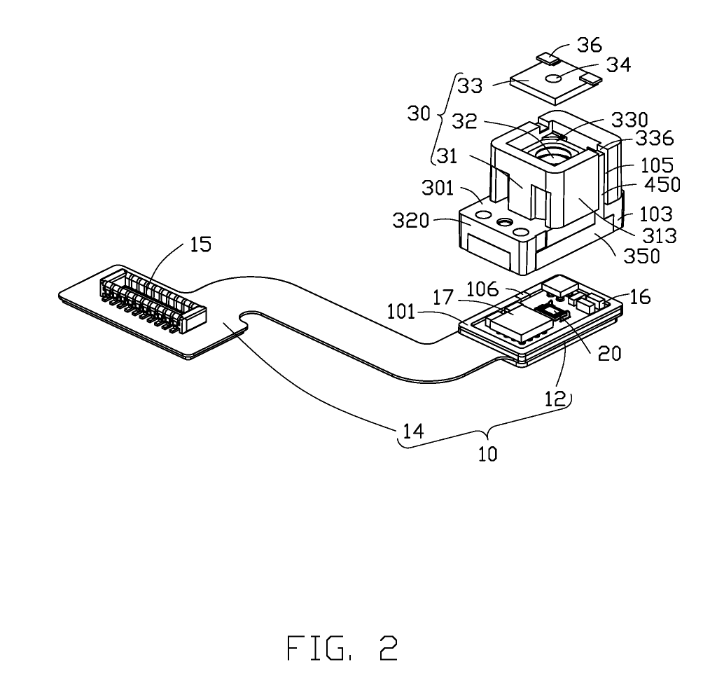

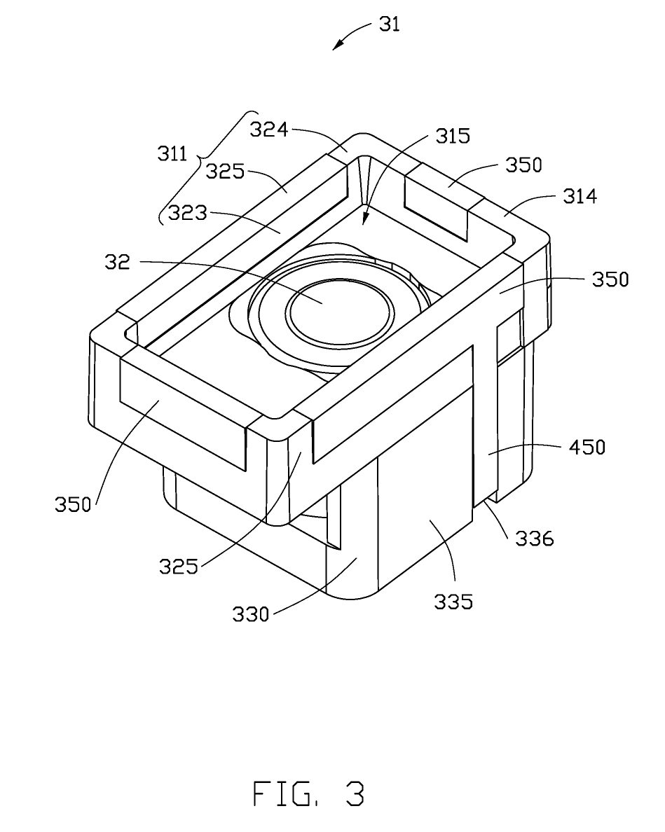

The printed circuit board 10 can be a flexible circuit board or a rigid-flexible board. In the illustrated embodiment, the printed circuit board 10 is flexible circuit board and a strengthening board 110 is formed on the bottom of the printed circuit board 10, as shown in FIG.3. The strengthening board 110 is made of metal and configured to dissipate heat away from the printed circuit board 10. The printed circuit board 10 includes a first portion 12 and an extending portion 14 connecting to the first portion 12, as shown in FIG.2. The first portion 12 is configured to support the light emitting element 20 and the optical member 30. The extending portion 14 is configured to support a connector 15, and the connector 15 is electrically connected to the light emitting element 20 and configured to transmit commands and signals between the optical projector module 100 and an external electrical device. The printed circuit board 10 further includes a plurality of passive components 16 mounted around the light emitting element 20. The passive components 16 includes resistors, capacitors, and inductors.

The printed circuit board 10 further includes a control unit 17 mounted beside the light emitting element 20. The control unit 17 is electrically connected to the light emitting element 20 and configured to adjust power fed to the light emitting element 20.

The light emitting element 20 is selected from VCSEL (Vertical Cavity Surface Emitting Laser), light emitting diodes (LEDs), infra-red (IR) LEDs, organic LEDs (OLEDs), infra-red (IR) lasers), and so on. In this embodiment, the light emitting element 20 is VCSEL array able to emit light with wave lengths at 830 nm or 950 nm or in between.

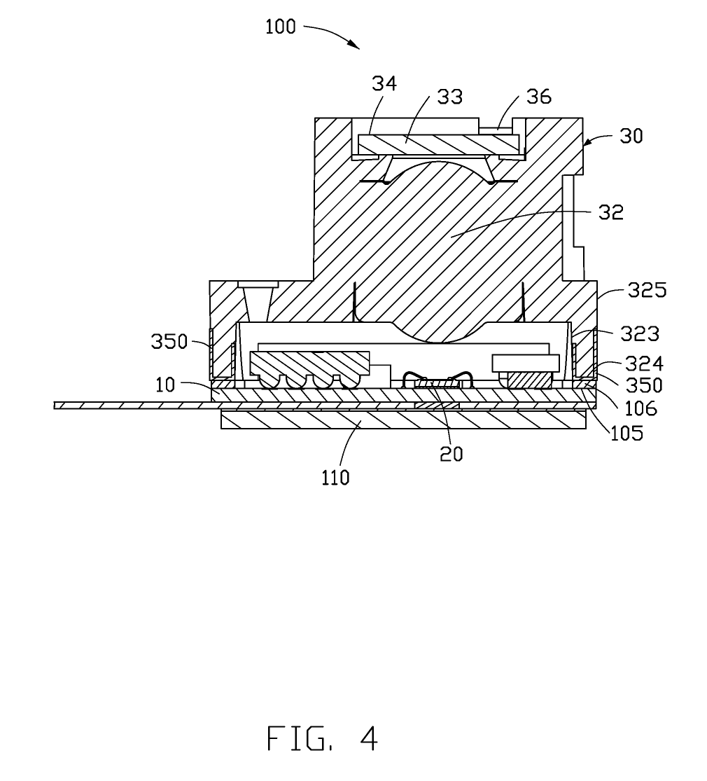

The optical member 30 in this embodiment includes a supporting structure 31, a collimating lens 32, and a diffraction optical lens 33, as shown in FIG.2. The supporting structure 31 is fixed adhesively or otherwise on the printed circuit board 10. In the embodiment, the supporting structure 31 is fixed on the first portion 12 of the printed circuit board 10 by an adhesive 101 arranged around the printed circuit board 10. The supporting structure 31 covers the light emitting element 20, as shown in FIG.4.

In the illustrated embodiment, the supporting structure 31 includes a flat plate 301, a first side wall 311 perpendicularly extending downwardly from an edge of the flat plate 301, and a second side wall 313 formed on the top plate 301 and perpendicularly extending upward to form a receiving holder 330. The second side wall 313 exposes a portion of the top plate 301. The first side wall 311 and the flat plate 301 together form a housing 315, as shown in FIG. 3 and FIG. 4. The housing 315 covers the light emitting element 20. The receiving holder 330 is configured to carry the collimating lens 32 and the diffraction optical elements 33.

The first side wall 311 is substantially square and includes an inner surface 323, a bottom end surface 324 perpendicularly connected to the inner surface 323, and an outer surface 325 perpendicularly connected to the bottom end surface 325. In the illustrated embodiment, the housing 315 is substantially rectangular and includes four sides 314, as shown in FIG. 3, adjacent sides 314 are perpendicular to each other.

A dissipating member 350 is embedded inside the housing 315 and extends outside of the housing 315. The dissipating member 350 is substantially L-shaped or U-shaped, and a material of the dissipating member 350 is a heat-conductive and electrically-conductive metal. In the illustrated embodiment, the metal dissipating member 350 is U-shaped, and the housing 315 is substantially rectangular and includes four sides 314. Each side 314 is formed with one dissipating member 350. Heat generated by the light emitting element 20 is first transferred to the inner surface of the housing 315, then reaches the dissipating member 350, and the U-shaped dissipating member 350 gradually dissipates the heat to the bottom end surface 324 and the outer surface 325. This avoids heat build-up in the housing 315. Thus, warping and distortion of the structure of the light emitting element 20 is avoided.

The optical projector module 100 further includes at least one conductive line 450 as shown in FIG. 2. The at least one conductive line 450 is formed on an outside surface of the second side wall 313, and the conductive line 450 is connected to the dissipating member 350 on the outer surface 325 of the second side wall 322. The conductive line 450 extends to the top end 336 of the receiving holder 330. In the illustrated embodiment, the optical projector module 100 includes two conductive lines 450 and the two conductive lines 450 are formed at opposite outside surfaces of the second side wall 322.

Both the conductive line 450 and the dissipating member 350 are formed using a same method, and a width of the conductive line 450 is far less than a width of the dissipating member 350. In this embodiment, the conductive line 450 and the dissipating member 350 are formed using a laser direct structuring (LDS) method.

The collimating lens 32 is received in the receiving holder 330, and is configured to receive and collimate light beams emitted from the light emitting element 20. The optical projector module 100 may include one or more collimating lens 32.

The diffraction optical lens 33 is received in the receiving holder 330, as shown in FIG. 4, and arranged in front of the optical path from the collimating lens 32. The diffraction optical lens 33 expands and emits the light beam from the collimating lens 32 into a fixed beam pattern.

The optical projector module 100 further includes a conducting film 34 formed on at least one surface of the diffraction optical lens 33, as shown in FIG. 4. The conducting film 34 can be formed at any one surface of the diffraction optical lens 33 or can be formed on opposite surfaces of the diffraction optical lens 33. In the illustrated embodiment, the conducting film 34 is formed on the surface of the diffraction optical lens 33 away from the diffraction optical lens 33. The conducting film 34 is also electrically connected to the printed circuit board 10. In this illustrated embodiment, the conducting film 34 is electrically connected to the printed circuit board 10 by the conductive lines 450 and the dissipating member 350. The printed circuit board 10 carries two second conducting members which correspond to the two conductive lines 450, each second conducting member is covered by conducting glue 105.

When the supporting structure 31 is mounted on the main portion 12 of the printed circuit board 10, the dissipating member 350 on the bottom end surface 324 is in direct contact with the conducting glue 106. The metal dissipating member 350 conducts electricity as well as heat, thereby the printed circuit board 10 is electrically connected to the conducting film via the conducting glue 106, the dissipating member 350, the conductive line 450, and the first conducting member 36.

The conducting film 34 can detect power of light beam emitted by the light emitting element 20. When power of the light beam emitted by the light emitting element 20 exceeds a predetermined value, electrical resistance of the conducting film 34 is changed, and the changed resistance is transmitted by the conductive line 450 to the control unit 17. The control unit 17 can adjust the amount of power or shut off power supplied to the light emitting element 20 based on the changed resistance.

The supporting structure 31 can be formed by one or more of the following steps, which may also be re-ordered when desired:

First, a laser-activated thermoplastic material is provided, and the material is injected into an injection mold to form a main body of the supporting structure 31. The material may be polycarbonate, butadiene, acrylonitrile, or styrene. The main body comprises a plate 301, a first side wall 311 perpendicularly extending downward from an edge of flat plate 301, and a second side wall 313 perpendicularly extending upward from the flat plate 301. The first side wall 311 and the flat plate 301 together form a receiving holder 330. The second side wall 320 and the flat plate 301 together form a housing 315.

Second, the inner surface 323, the bottom end surface 324, and the outer surface 325 of the second side wall 320 are irradiated by a laser beam. Cutouts which form a first layout path 103 and a second layout path 105 are created.

Third, The forming of the first layout path 103 and the second layout path 105 clears debris from the laser processing.

Fourth, the main body is placed into a metal electrolyte for electroplating to form the heat dissipation member 350 at the first layout path 103. The conductive line 450 at the second layout path 105 is also formed, and thereby the bearing structure 31 is obtained. If a thicker heat dissipation member is needed, electroplating method can be repeated.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. An optical projector module comprising:
a printed circuit board;
a light emitting element mounted on the printed circuit board; and an optical member mounted on the printed circuit board, wherein the optical member comprising:
a supporting structure, the supporting structure comprising a top plate and a first side wall perpendicularly extending downwardly from an edge of the flat plate, the first side wall and the flat plate together form a housing, the housing shades the light emitting element,
a dissipating member embedded inside an inner surface of the housing and extending outside of the housing, and
the dissipating member is made of metal and able to conduct heat and electricity.

2. The optical projector module of claim 1, wherein the light emitting element is selected from vertical cavity surface emitting laser, light emitting diodes, infra-red LEDs, organic LEDs or infra-red lasers.

3. The optical projector module of claim 1, wherein the housing further comprises a bottom end surface perpendicularly connected to the inner surface, and the dissipating member is substantially L-shaped and extended to cover the bottom end surface.

4. The optical projector module of claim 1, wherein the housing further comprises a bottom end surface perpendicularly connected to the inner surface, and an outer surface perpendicularly connected to the bottom end surface, and the dissipating member is substantially U-shaped and extended to cover the bottom end surface and the outer surface.

5. The optical projector module of claim 1, wherein the supporting structure further comprises a second side wall formed on the top plate and perpendicularly extending upwardly to form a receiving holder, and the optical member further comprises a collimating lens, and the collimating lens received in the receiving holder.

6. The optical projector module of claim 5, wherein the supporting structure further comprises a diffraction optical lens, the diffraction optical lens received in the receiving holder and arranged in front of the optical path of the collimating lens.

7. The optical projector module of claim 6, wherein the optical projector module further comprises a conducting film formed on at least one surface of the diffraction optical lens, and the conducting film electrically connected to the printed circuit board.

8. The optical projector module of claim 7, wherein the outside surface of the receiving holder is formed with at least one conductive line, the conducting film is electrically connected to the printed circuit board by the conductive lines and the dissipating member.

9. The optical projector module of claim 8, wherein the printed circuit board is a flexible circuit board or a rigid-flexible board, the printed circuit board comprises a first portion and an extending portion connecting with the first portion, the light emitting element and the optical member are mounted on the first portion.

10. The optical projector module of claim 9, wherein the printed circuit board further comprises a control unit mounted besides the light emitting element, the control unit is electrically connected to the light emitting element and configured to adjust the power of the light emitting element.

11. The optical projector module of claim 1, wherein the printed circuit board further comprises a connector mounted on the extending portion, the connector is configured to transfer a signal of the optical projector module to external electrical device.

12. The optical projector module of claim 11, wherein a width of the conductive line is less than a width of the dissipating member.

13. The optical projector module of claim 12, wherein the optical member is fixed on the first portion by adhesive.

14. The optical projector module of claim 13, wherein the conductive line electrically connected to the conducting film by a first conducting portion.

15. The optical projector module of claim 14, wherein the printed circuit board further comprises a second conducting portion, and a conducting glue is formed on the second conducting portion, and the dissipating member contacts the conducting glue.

16. The optical projector module of claim 14, wherein the printed circuit board further comprises a strengthening board formed on the bottom of the first portion.
